(19) United States
(12) Patent Application Publication
(10) Pub. No.: US 2018/0094801 A1
(43) Pub. Date: Apr. 5, 2018

(54) MODULARIZED LIGHTING DEVICE

(71) Applicant: Ching-Yu Lu, Kaohsiung City (TW)

(72) Inventor: Ching-Yu Lu, Kaohsiung City (TW)

(21) Appl. No.: 15/281,071

(22) Filed: Sep. 30, 2016

(51) Int. Cl. F21V 23/06; H05B 37/02; F21K 9/272; F21K 9/278; F21K 9/235; F21K 9/238

(52) U.S. Cl. CPC F21V 23/06; H05B 37/0272; F21K 9/272; F21Y 2115/10; F21K 9/235; F21K 9/238; F21K 9/278

(57) ABSTRACT

The modularized light device includes a main member and at least a functional member. The main and functional members have matched conductive terminals, allowing them to be end-to-end cascaded together and installed altogether onto a base. When the base provides electricity, the main member illuminates and each of the functional members performs a specific electronic function. In other words, the lighting device provides not only illumination but also electronic functions adaptable to user requirements, achieving great applicability and convenience.

### BACKGROUND OF THE INVENTION

### (a) Technical Field of the Invention

The present invention is generally related to lighting devices, and more particular to a lighting device having modularized functional members to provide adaptable electronic functions in addition to illumination.

### (b) Description of the Prior Art

Light is probably the most important part of people's life. For both day and night, people need lighting for their living convenience.

On the other hand, due to technology advancement, many electronic appliances are miniaturized with even greater functionality and portability. In these days, they may even be controlled through various APPs with significance convenience. The miniaturized appliances is also easier to be integrated to and applied with other devices.

As such, if lighting device which provides illumination and the various electronic appliances can be integrated together, even greater living convenience may be attained.

### SUMMARY OF THE INVENTION

Therefore a novel lighting device is provided herein. The lighting device, in addition to illumination, has modularized and replaceable functional members to provide adaptable electronic functions.

The lighting device includes a base, a main member, and at least a functional member. The main member has a lighting module inside and at least a first conductive terminal at one end electrically connected to the lighting module. Each functional member has a second conductive terminal at one end, a third conductive terminal at another end, and a circuit board with a specific electronic function inside electrically connected to the second and third conductive terminals. The main member and the functional members are end-to-end connected together and altogether installed onto the base. When the base provides electricity, the electricity is conducted through the main and functional members. The lighting module is lit, and each circuit board performs its specific electronic function.

The main member is a lamp tube or a light bulb.

The second terminal is corresponding to and is for connection with the first conductive terminal of the main member, or the third conductive terminal of another function member.

Each circuit board is one of a network base station, a Bluetooth transmitter/receiver, an infra-red sensor, a near-field communication (NFC) transmitter/receiver, a network camera, a power supply, and an environmental detector.

The advantage of the present invention lies in that the main and functional members share a same electrical power source and, when the lighting device is turned on, the main member illuminates and the functional members also perform specific electronic functions, enhancing the lighting device's applicability and flexibility.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a lighting device according to the present invention.

FIG. 2 is a functional block diagram showing the lighting device of FIG. 1.

FIG. 3 is a perspective diagram showing a lighting device according to an embodiment of the present invention.

FIG. 4 is a perspective diagram showing a lighting device according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

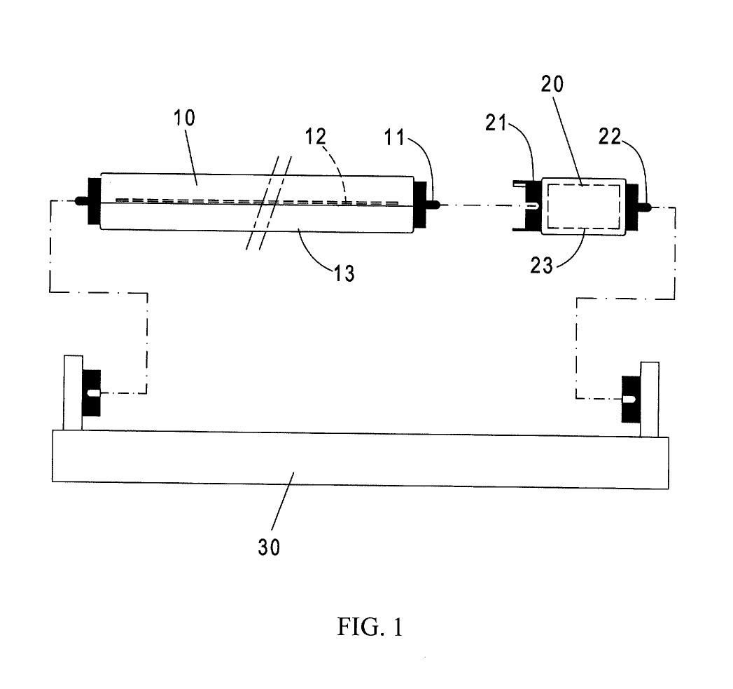

As shown in FIG. 1, a lighting device according to the present invention includes a main member 10 and at least a functional member 20. The functional member 20 is an electronic apparatus of a specific function. The main member 10 includes light emitting diodes (LEDs) for illumination. The main member 10 has two ends and each end has a first conductive terminal 11. The functional member 20 also has two ends, one end having a second conductive terminal 21 and the other end having a third conductive terminal 22. The second conductive terminal 21 is for connection with a first conductive terminal 11 of the main member 10, or a third conductive terminal 22 of another function member 20. As such, the main member 10 and a number of functional members 20 can be end-to-end cascaded into a chain and disposed on a base 30 altogether. As the main member 10 and the functional members 20 are electrically connected together, they form a closed circuit together with the base 30. By providing electricity through the base 30, the main member 10 and the functional members 20 are able to obtain their required voltage and function independently.

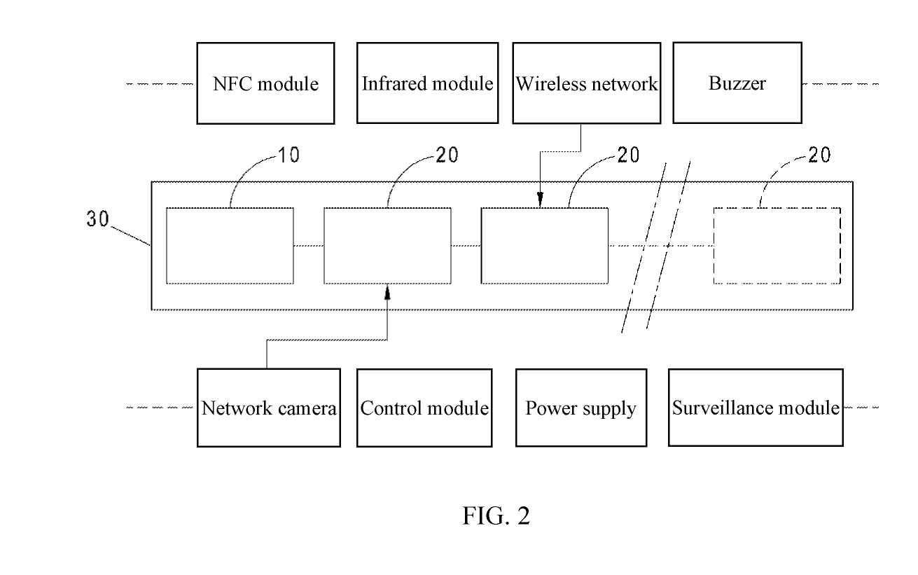

As shown in FIGS. 1 and 2, each functional member 20 includes a circuit board 23 and each circuit board 23 is designed to perform a specific function so that each function member 20 is capable of wireless communication, data transmission, sensing and control, etc. and may function as a WiFi base station, a network camera, a Bluetooth transmitter/receiver, a controller, an Infra-red sensor, a speaker, etc. Therefore a user may, depending on his/her application requirement, select a set of functional members 20 and install them together on the base 30. The circuit boards 23 of the functional members 20 then operate independent after electricity is applied through them.

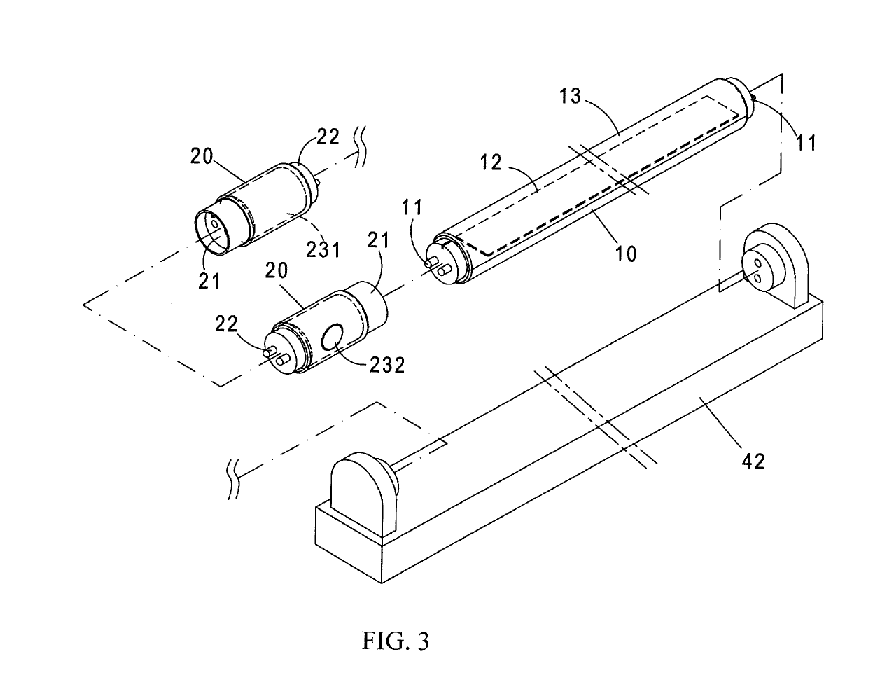

FIG. 3 provides an embodiment of the present invention. As illustrated, the main member 10 is a lamp tube with a LED lighting module 12 inside connected to conductive terminals 11 at both ends. The required working voltage for the LED lighting module 12 is provided through the conductive terminals 11. Light produced by the LED lighting module 12 then illuminates through a lamp shade 13 of the main member 10. The second conductive terminal 21 is shaped correspondingly with the first and third conductive terminals 11 and 22 so that they can be joined together to establish electrical connection. Therefore in the present embodiment the main member 10, a first functional member 20 with a first circuit board 231, a second functional member 20 with a second circuit 232 are cascaded together. Electricity is conducted through and distributed among the main member 10 and the two functional members 20. In the present embodiment, the first circuit board 231 is a WiFi base station and the second circuit board 232 is a network camera. The present invention however is not limited as such. The present embodiment therefore has the main member 10 as a light source and, in the meantime, has the functional members 20 to provide WiFi access and networked image capture.

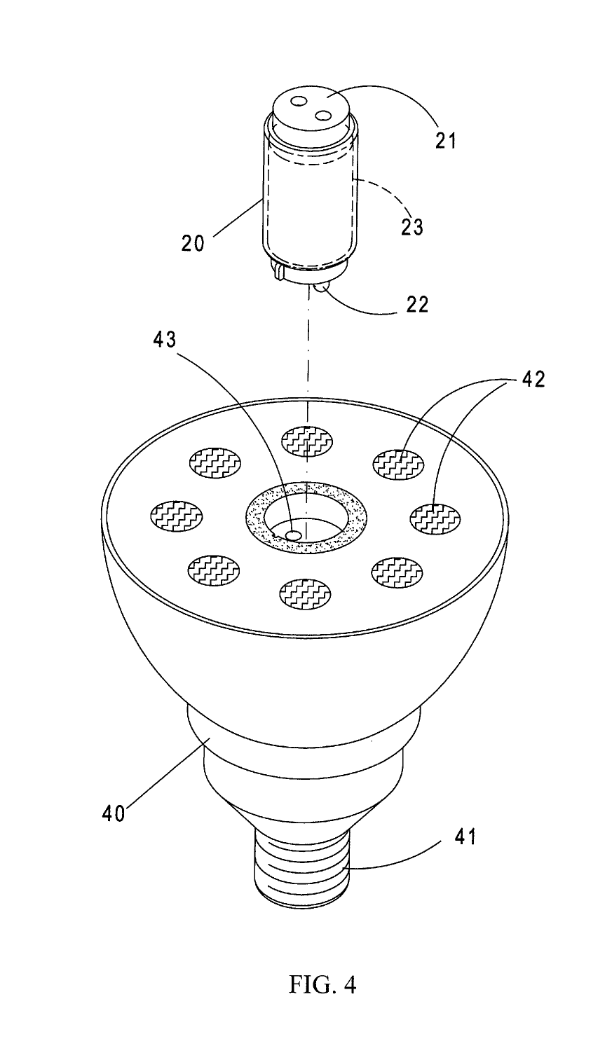

Please note that there can be various variations to the shapes, dimensions, and styles of the main and functional members and their terminals. For example, the main member may be a lamp tube or a light bulb. The terminals may be configured at one end or both ends. These variations are all within the scope of the present invention. As shown in FIG. 4, the main member 40 of the lighting device is a LED light bulb with a lighting module 42, a fourth conductive terminal 41 for plugging into a socket for the light bulb, and a first conductive terminal 43 for connection and establishing electrical contact with the functional member 20. When the lighting device is turned on and the main member (light bulb) 40 illuminates, the functional member 20 also performs a specific electronic function, enhancing the lighting device's applicability and flexibility.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A lighting device, comprising
a base;
a main member having a lighting module inside and at least a first conductive terminal at one end electrically connected to the lighting module; and
at least a functional member, each having a second conductive terminal at one end, a third conductive terminal at another end, and a circuit board with a specific electronic function inside electrically connected to the second and third conductive terminals;
wherein the main member and the functional members are end-to-end connected together and altogether installed onto the base; when the base provides electricity, the electricity is conducted through the main and functional members; the lighting module is lit; and each circuit board performs its specific electronic function.

2. The lighting device according to claim 1, wherein the main member is a lamp tube or a light bulb.

3. The lighting device according to claim 1, wherein the second terminal is corresponding to and is for connection with the first conductive terminal of the main member, or the third conductive terminal of another function member.

4. The lighting device according to claim 1, wherein each circuit board is one of a network base station, a Bluetooth transmitter/receiver, an infra-red sensor, a near-field communication (NFC) transmitter/receiver, a network camera, a power supply, and an environmental detector.
